(19) United States
(12) Patent Application Publication
(10) Pub. No.: US 2019/0015761 A1
(43) Pub. Date: Jan. 17, 2019

(54) Planetary Countercurrent Chromatography Centrifuge and Mixer-Settler Rotor

(71) Applicant: CC Biotech LLC, Rockville, MD (US)

(72) Inventors: Martha Knight, Washington, DC (US); Ben Feldman, Reston, VA (US); Eric Cabahug, Fairfax, VA (US)

(21) Appl. No.: 16/038,080

(22) Filed: Jul. 17, 2018

Related U.S. Application Data
(60) Provisional application No. 62/533,428, filed on Jul. 17, 2017.

(51) Int. Cl. B01D 15/22; B01D 15/18; G01N 30/42; B01D 15/24

(52) U.S. Cl. CPC B01D 15/22; B01D 15/1807; B01D 15/247; G01N 30/42; B01D 15/1892

(57) ABSTRACT

A mixer-settler countercurrent chromatography centrifuge and rotor of increased capacity is described.

Portions of the research described herein were supported in part by NIH grant no. R43AT008296-01 to CC Biotech, Rockville, Md.

### BACKGROUND OF INVENTION

Carbon nanotubes (CNT), carbon-carbon extended polymers with fused sp2 orbitals, have aromatic properties [1,2]. Sheets are known as graphenes and can form tubes, nanotubes. Tubular forms are of various diameter from about 1 rim to a few hundred urn and have lengths of about 500 nm to several thousands of nanometers. Nanotubes are single-walled or multi-walled, having anisotropic structures. Nanotubes exhibit conductive or semiconductor properties, and are chiral. The hexagonal array of the atoms is in a left-handed or a right-handed spiral pattern. Dimensions of patterns of a hexagonal honeycomb lattice are described by vectors, m and n, where nanotubes of certain values of m and n being semiconducting. A, ‘zig-zag,’ pattern where m=0 and an, ‘arm chair,’ pattern where n=m (metallic) are non-chiral structures. Longer CNT's generally are metallic. CNT's are hard, strong and chemically stable materials, with higher thermal and electrical conductivity.

CNT's are components of different devices. For example, semiconducting CNT's are used in memory devices and sensors, and metallic CNT's are used in electrodes and electromagnetic shields.

Methods of producing particular CNT's include chemical vapor deposition and arc discharge on catalysts. Some methods do not produce a high amount of semiconductor types and some methods seed desired types, however, yields of particular forms are limited.

Semiconducting species of carbon nanotubes have been separated by ultracentrifugation and ion exchange column chromatography [1,3-6]. Yields from ion exchange are small and differential gradient ultracentrifugation yields small fractions, although chiral enantiomers are separated [3,4]. Some processes separate based on surface charge, which can vary with size of particles [4]. CNT's that are chemically modified with, for example, siRNA, can be purified by high performance liquid. chromatography (HPLC) (see, for example, [16] using DNA). However, HPLC recoveries are not quantitative [7]. Thus, methods to achieve monodisperse species with increased mass recoveries are needed.

Countercurrent chromatography (CCC) is a partition chromatography technology whereby substances are separated according to partitioning between a moving liquid phase through, about, within and so on, a stationary liquid phase in a lengthy path. Separated compounds emerge from path end and are collected in fractions. In a known device, a process occurs in a coil of tubing with a continuous flow of solvents therethrough without a rotating seal [8] rotated in a planetary centrifuge around a central axis. Solvents are mixed in certain volume ratios to make two stable immiscible phases: one serves as a stationary phase (SP) and a certain fraction thereof remains in a coil under centrifugation at equilibrium, while a mobile phase (MP) is pumped through a tubing, separating analytes during centrifugation. Either phase can be utilized as an MP. CCC does not use expensive solid supports or column packing taking up volume. Higher SP volume holds more sample mass.

In CCC, a solvent system can be devised to fractionate a sample removing impurities or separating mixtures. Tubing coils or spools (multi-layer CCC columns or rotors) centrifuged at about 800 rpm using flow rates of about 2 ml or higher, retain about 60-80% of SP volume held by Archimedean screw force and centrifugal force field. Solvent systems can be organic-aqueous compositions of rapidly separating phases with high interfacial tension. Solvents can include, for example, hexane, t-butyl methyl ether, chloroform and the like.

CCC has been used to isolate natural products and products of organic synthesis reactions. But, for more polar molecules, such as, peptides [9] which are soluble and partition well in alcohol solvent systems, coils do not perform as well.

In recent years, a spiral disk CCC system was developed [10,11] which comprises a stack of plastic disks with spiral channels that are connected with openings for continuous flow in, between and among discs. Increased pitch of a flow pathway served to retain better an SP of more polar solvent systems and aqueous two phase solvent (ATPS) systems. That made possible separation of larger molecules, such as, proteins [9,12,13].

An original spiral disk CCC rotor had 8 plates or disks, each with a single spiral clockwise (CW) oriented channel thereon from center out [10]. Flow into a rotor went through plastic tubing from a pump for sample delivery and fluid flow connected to a threaded hole in a top metal plate and entered through a gasket hole into the center of a first disk. Between each plate was a TEFLON® (TEFLON is a trademark of Chernours, Wilmington, Del. and is a polytetrafluoroethylene thermoplastic polymer than can be constructed as a membrane or other forms) sheet or gasket to cover and to hold liquid in a channel. Flow began at a spiral channel end closer to center of a disc and proceeded to an outer end of that spiral, solvent flow exited through a hole to a channel underneath that plate or disk and flowed to the center of that disc to a hole near the center of an adjacent gasket below that plate to start of a spiral in a next plate below. That is repeated and at a last disk, flow goes through a center hole through an adjacent gasket below to a threaded fitting in a bottom metal plate to a plastic tubing which courses to a fraction collector. Plastic tubing served for in-flow and out-flow from a rotor through the centrifuge axis.

Later, shaping of spiral channels or grooves on a superior or upper face of a disc was modified to produce better mixing and to increase efficiency of separation. Additionally, to increase retention of an SP and hence, efficiency of separation, multiple interweaved spirals were designed in a plate with flow moving from end of one spiral to beginning of a next spiral by a radial channel beneath or on an inferior surface of that disc to enable flow to start on a next spiral on a disc, then on to a next disc or out a rotor. For example, four interweaved spirals on a rotor increased distance between flow channels or pitch, four times or more. That served to increase retention of viscous solvent systems, such as, a polyethylene glycol (PEG)-phosphate ATPS system. Large molecules, such as, proteins, were separated.

Also, spirals in a high density polyethylene (HDPE) disk were modified with a device to impede flow, such as, a protrusion across a channel, which, in that case, held a mixing bead in every other, alternating or non-consecutive segment [14] which served to provide mixing of phases and subsequent settling of phases as well as passing of a phase through a side of and around a protrusion. Repeated mixing and settling of fluids provide better resolution, and settling retains SP in a rotor.

Thus, a rotor of five spiral disks was used for protein separation and baseline separation of proteins of molecular weight (MW) of up to 63,000 daltons, cytochrome c, myoglobin, ovalbumin, lysozyme and bovine serum albumin (which was retained in a rotor.) Another separation of a mix of five higher MW proteins into separate populations, 5 mg cytochrome c, and 20 mg each of human serum albumin, β-lactoglobulin, α-chymotrypsin and trypsinogen, was achieved [15] using an ATPS system at a flow of about 0.5 ml/min at a speed of about 800 to about 1000 rpm.

However, there remain issues with rotors disclosed in, for example, U.S. Pat. Nos. 7,892,847 (hereinafter, “the '847 patent,”) and CN 201143392Y, such as, after use at higher centrifugation speed, leaks occurred through gaskets and flow was blocked leading to lower flow rates, even for washes. Leaks occurred near an outer periphery and toward a center shaft. Also, friction between and among moving parts generated wear and heat.

However, separating larger molecules, including carbon nanotubes (CNT's), requires higher centrifugation speed. Disks need to be stronger, for example, previous discs were made of polypropylene which warped or deformed throughout a surface area of a disc and mixing glass beads were not secure.

Hence, a new rotor, new rotor set up and/or materials and methods for separating complex mixtures, such as, of larger molecules, such as, CNT's with higher yield, are needed. There is a need for separating types of CNT's, such as, those of specific chirality, those that are semi-conductive and so on, at higher yield.

To enhance separation of larger volumes, more viscous reagents, in shorter preparation times, at higher yield, and/or to separate larger molecules, improved centrifuge and rotor designs and components are needed.

There is a need to increase yield and throughput. However, doing so is not a mere exercise in scaling where measurements, for example, of tubing diameter, tubing length, centrifugation speed and so on are uniformly increased by a factor. Because of the plural factors that influence separation, plural factors need to be considered and scaling is non-linear across the devices and methods.

### SUMMARY OF INVENTION

A new rotor, rotor components and planetary centrifuge are described for separating mixtures of larger molecules, such as, carbon nanotubes (CNT's). A disc of a rotor is made of more durable plastic and can be less than about 5 mm thick. A disc comprises radial channels on an inferior or lower face or surface of a disc that are at least 1 mm in depth to connect interweaved spiral channels on the upper surface. A disc of a rotor of interest comprises a rim about or near an outer perimeter of a disc and another rim about a void at a central region of a disc on a lower or inferior face of a disc, and on an upper or superior face of a disc. The void at a central region describes, but is not in contact with a planetary shaft. A rim facilitates seating of a gasket to and on a disc to ensure, for example, at a lower face of a disc, an even seal of the upper and lower faces of a disc, such as, of radial channels on that inferior surface of a disc, and facilitates application of uniform pressure on a disc, such as, a lower side or face of a disc from a central region out to an outer periphery and outer edge of a disc. Upper and lower supporting or end plates can be thicker, an upper plate being at least about 7 mm in thickness and a lower plate is at least about 4 mm thick, to apply even and secure pressure on an assembled stack. However, to avoid higher rotor weights without sacrificing structure and support, end plates can be hollowed and comprise ribbing, vertical to the plane of the endplate. Also, fasteners to secure a stack of end plates, discs, gaskets and so on, are selected to distribute pressure as broadly and evenly as possible to enable more even sealing pressure within a rotor. For example, fasteners not integrated in an end plate may be used to minimize wear on fasteners and on an end plate used with such a fastener. Hence, if a screw is a fastener, a suitable device is to replace treads in a lower end plate with a nut to secure said screw. On the end plate sides facing away from the disc and gasket stack, that is, located on an outside face of the rotor stack, as noted above, those sides of the end plate can comprise ribs, radial arms and the like to provide structural support, stiffness and the like to the end plate with less weight.

In embodiments, to facilitate separation of larger molecules with existing rotors, gaskets were devised, for example, to reduce leaking, to ensure better fit among components, to ensure continuous flow and to enhance run life of an existing rotor. A gasket can be more deformable or compressible. Such a gasket can be constructed of an elastomer, such as, a fluoropolymer, a synthetic rubber, an artificial rubber and so on, or combinations thereof. Another gasket comprises radial slits in register with radial channels at an inferior surface of a disc. Radial channels of a gasket complement semicircular, open or incomplete voids of radial channels or slits of a disc, forming an enclosed, closed void when that gasket engages a bottom face of a disc to ensure a gasket does not impede flow in a radial channel of a disc. A gasket comprises a radius shorter than that of a disc and the outer edge of the gasket engages ridges or rims of a disc. An optional gasket can have a smaller radius than other gaskets or a disc, can be made of a more rigid material and is sited or seated at central portions of a rotor and disc, about a central void to provide additional sealing in central regions of a disc, of a stack of discs or of a rotor. Such an optional rigid gasket can serve as a washer to provide better sealing at central portions of a rotor assembly, about discs, about gaskets and so on. Design of a gasket takes into account any fastening device at an outer periphery of a disc and at a central region of a disc, as well as presence of a rim. For example, if screws or pins are a fastening means, a rim can be located more remote from a center and from screw or pin sites of a disc, for example, at an outer perimeter of a disc, in which case, a gasket comprises holes or portions of holes in register at sites of a screw or pin to allow passage of that screw or pin through that gasket when a rotor is assembled.

In embodiments, a rotor of at least 22 cm in diameter is used, which enables discs approaching or of at least 22 cm in diameter to be included in a rotor stack, which increases rotor volume.

A rotor can comprise any number of discs (and corresponding gaskets) as a design choice. Discs can be thinner, but disc also can be thicker to accommodate more tubing. Hence, the number of discs can vary depending on selection of components, the constraint being the size of the rotor. In embodiments, a rotor comprises at least 6 disks, at least 7 discs, at least 8 disks, at least 9 discs or more.

In embodiments, discs (or disks) of interest have a diameter of at least about 7.5 inches or of at least about 22.5 cm, The spiral channels are designed to have defining walls the height of the disc or channel to engage a gasket. Partitions, radial channels and the like distributed throughout the disk face are designed to have a height less than that of the channel walls resulting in a gap between an overlying or underlying gasket and the disc face between channel walls, in the disc face between an outer rim and the outermost channel wall, and in the disc face between the inner rim and the innermost channel wall. The gaps enable deformation of gaskets between discs, or between a disc and an endplate to provide a good seal, through channels, slits and the like with the disc and gasket stack when secured with fasteners.

In embodiments, the discs and gaskets describe a void around the planetary shaft of the planetary centrifuge shaft. That space between the discs/gaskets and the shaft minimizes friction and movement of rotor components in a secured stack and provides space for gasket expansion or deformation, if needed, when the sandwich of discs and gaskets in the rotor is secured and tightened.

The shaft of the planetary centrifuge can be designed and manufactured as a unitary structure comprising at a lower or inferior portion which is in contact or is in register with a rotor, a flared portion, a shelf, a rim, a lip, a protrusion and the like, which can be continuous about the shaft circumference or can be in potions about the circumference of the shaft, which can be of any thickness appropriate for the function, which flared portion provides a shelf, a seat, a platform, a support and the like for the rotor and onto which the lower face of rotor abuts or contacts. Hence, the rotor rests on that platform. The shelf and the lower face of the rotor can have “male” and “female” structures that engage and seat and/or fix the rotor to the shelf and hence, to the shaft. Such engaging devices can include, for example, a pin, a bar, a stub and the like on one face and an accommodating receiving hole or void on the other, and so on. A planetary shaft can comprise terminal flared portion at one or both ends of the shaft.

The solar and planetary shafts of the centrifuge are oriented vertically so that rotor motion is in a horizontal plane. That orientation enhances attaining phase equilibrium, such as, with viscous solvents.

In embodiments, an aqueous two phase solvent (ATPS) system is used to isolate populations of CNT's. For example, one phase comprises polyethylene glycol (PEG) and a second phase comprises dextran, both in water. PEG is from about 6,000 to about 10,000 molecular weight (MW) and dextran is from about 60,000 to about 90,000 MW. Two phases can be produced as a 10% by weight PEG solution and a 16% by weight dextran solution. A 3:2 v/v ratio mixture of the PEG solution to the dextran solution spontaneously forms two phases on standing, and the two solutions can be used as two phases to separate CNT's in countercurrent chromatography (CCC.)

### BRIEF DESCRIPTION OF THE FIGURES

The following description of the figures and the respective drawings are non-limiting examples that depict various embodiments that exemplify a present invention.

FIG. 1 is a stack of discs in a rotor for performing centrifugal countercurrent chromatography for separating molecules.

FIG. 2 is a line diagram of a rotor stack. The cross-hatched or stippled. portion about the outer perimeter of the shaft in the stack of the plates and gaskets define a void where the plates and gaskets do not contact the shaft.

FIG. 3 depicts a spiral disc with mixing glass beads in place.

FIG. 4 is a line diagram depicting barricades and beads in a portion of a disc. The notation, ng, refers to a multiple of gravity.

FIG. 5 depicts an exploded view of a stack of components of a rotor with a top end plate at the top and to the left, a stack of interleaved discs and gaskets, a slitted gasket, a disc and a lower end plate at the bottom and to the right.

FIGS. 6A-E depict components of a rotor of interest, with two spiral discs (FIG. 6A and FIG. 6E) framing a slitted gasket (FIG. 6B), an optional washer (FIG. 6C) and a compressible gasket (FIG. 6D).

FIGS. 7A and 7B are photographs of a top (A) and a bottom (B) of a mixer-settler disc.

FIG. 8 is a line drawing of a rotor stack. 1 is the shaft. 2 is a nut of fastener of the rotor stack. 3 is a platform of a shaft to support the rotor. 4 are endplates. 5 is a disc/gasket stack void about the shaft. 6 is a fastener of the rotor to the shaft. 7 is the rotor/gasket stack. The darker portions depict gaskets, which have a diameter less than that of the discs.

FIG. 9 is a line drawing depicting the varying heights of a channel wall and that of a partition.

FIG. 10 depicts ribs on the reverse side of an end plate, not in contact with a disc or a gasket, and facing out from the rotor stack, to provide structural support and minimizing weight.

FIGS. 11A and 11B provide features of a gasket and a disk. FIG. 11A depicts a gasket with a hard stop, a lip, a rim and the like at the central void that describes the planetary shaft space. FIG. 11B depicts a similar structure of a disc, that can be in register with a hard stop of a gasket or can be of a size that just engages the rim of the other component, either on the outer side of the engaged rim or on the inner side of the engaged rim to provide further structural support and stability of the stack of discs and rotors in the stack.

FIG. 12 depicts a rotor stack demonstrating the interplay between hard stops in plates or discs and with gaskets at the outer edge of the disks and gaskets.

FIG. 13 depicts the face of a disc with a gasket thereon.

FIG. 14 depicts a rotor assembly where the flared planetary shafts are visible.

### DETAILED DESCRIPTION OF THE INVENTION

As used herein, a superior or top face of a disc comprises the spirals, channels, grooves of interest for comprising the stationary and mobile phases for separation.

An inferior or bottom face of a disc does not comprise the spirals, channels, grooves of interest, but may contain a hole or a void, a rim, a border, a partition and so on. Separation of reagents or analytes does not occur on an inferior or bottom face of a disc.

A rotor of interest is generally cylindrical or circular in shape with an increased approximate diameter of at least about 22 cm, at least about 24 cm, at least about 26 cm, at least about 28 cm, or larger, such as, 22.5 cm, 23 cm, 25 cm and so on, and a height of at least about 10 cm, at least about 11 cm, at least about 12 cm, at least about 13 cm, or taller, as compared to existing rotors with an outer diameter (OD) of 17.5 cm and a height or 5 cm.

An accommodating centrifuge can have a revolution radius (distance between the solar axis and the planetary axis) increased from about 10 cm to about 13 cm. The revolution radius can be at least about 13 cm, at least about 14 cm, at least about 15 cm, at least about 16 cm, or greater.

A centrifuge of interest can be operated at higher speeds, for example, at least about 1000 rpm, at least about 1100 rpm, at least about 1200 rpm, at least about 1300 rpm or higher speeds.

With the revolution radius incrementally increased from about 10 cm to about 13 cm, with a concomitant increase in disc size of about 5 cm in diameter, from 17.5 cm to about 22.5 cm, and speed increased from 840 rpm to 1200 rpm, the relative centrifugal field (a function of revolution radius and speed) was increased from x79 g to x209 g, a greater than 2.5× increase. RCF can be increased 2×, 2.25×, 2.75×, 3×, 3.5×, 4× or more.

Relative centrifugal field (RCF) can be calculated using the formula, RCF=11.17r×(RPM/1000)², where r is the revolution radius in centimeters.

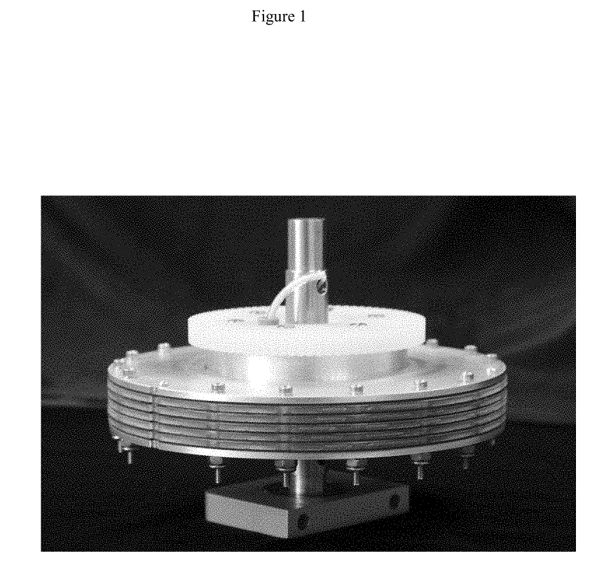

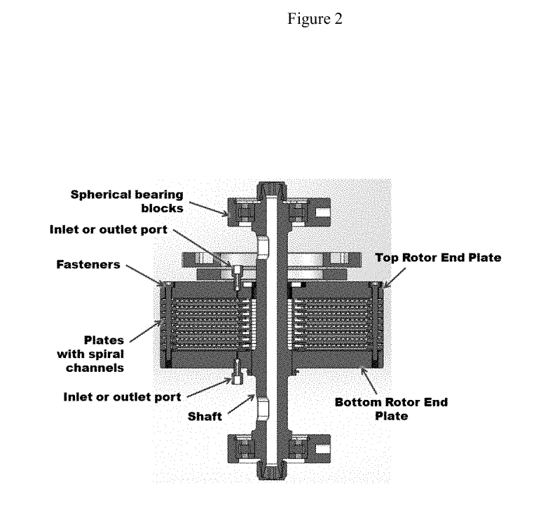

FIGS. 1 and 2 depict an assembled rotor with black VITON® sheets between clear polycarbonate disks and at an outer perimeter are screws and nuts to secure the stack. Disks can be designed to have interweaved grooves or spirals, such as, four or more interweaved spirals serially connected by channels underneath or on the side of a disc opposite to that comprising spiral channels to provide flow from one end of an interleaved spiral to beginning of a next interleaved spiral on a disk and then to a disk below through an opening in a gasket.

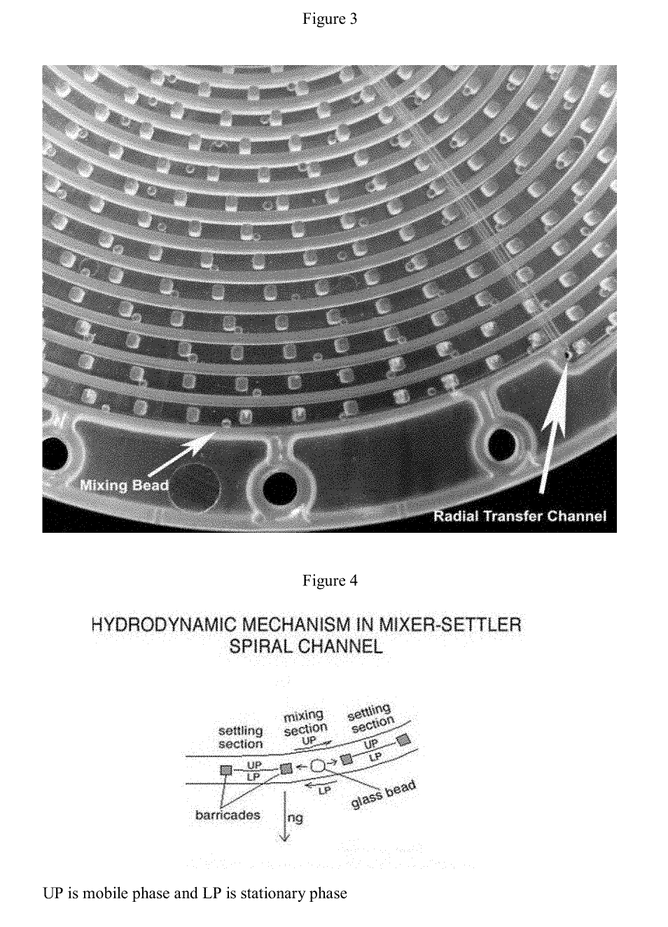

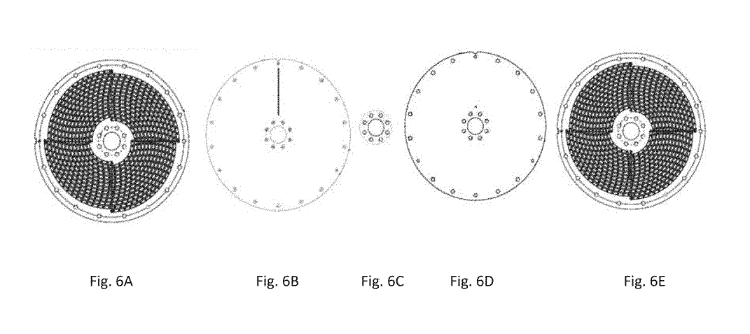

In channels (also used interchangeably herein with, “grooves,” “slots,” “slits,” and “spirals,”) are impediments to flow, such as, protrusions, such as, pins or partial walls, glass beads, barrier and so on, generally, that do not touch either side of a groove or channel wall, generally do not contact a gasket above a disc to enable gasket expansion and/or deformation. Not wishing to be bound by speculation or theory, it is believed flow impediments impact flow of phases, such as, upper phase (UP) close to the center of a channel and lower phase (LP) on sides of an impediment outward from the center. SP gets, ‘retained,’ in settling sections that do not have an impediment, as depicted in FIG. 4 (as known, either UP or LP can be an SP or a mobile phase (MP) [14]). A plastic disk with glass beads in place is shown in FIG. 3. Spiral channels can be about 3 mm wide and about 2 mm deep, but can be larger to increase tubing capacity. A drawing of a plastic disk with four spirals and barricades and how a disc is arranged in a rotor assembly is shown as A in FIG. 6, Straight channels on an inferior surface of a disc visualized in A of FIG. 6 are less than 1 mm deep.

A feature of planetary motion is no tangling or twisting of tubing that enters and exits the planetary rotor. Nonetheless, with solar and planetary motions, with speeds of 1000 rpm or more, tubing at the rotor ingress and egress sites undergo considerable movement. Hence, to minimize wear on tubing, a rotor can provide protection of incoming and outgoing tubing, in the form of, for example, a protective and/or insulated sleeve through which a tubing traverses into and out of a rotor. That sleeve can be a tubing of larger diameter, constructed of more durable material, contain insulating material to dampen movement within the sleeve and so on, to protect and to prevent wear on tubing entering and exiting a rotor of interest.

Hence, a tubing protector can comprise an insulating or dampening material surrounding a tubing of interest, such as, a foam, a sponge, a hydrogel and so on. The sleeve can be crenulated, crinkled, comprise an, “accordion,” surface, grooved, corrugated and so on, such as, a bending straw, to facilitate bending of the sleeve and of the tubing within.

In embodiments, a tubing protector can be contained within a more durable material, such as, a ceramic, a plastic, a metal and so on, to provide additional support for the tubing, to allow greater clearance for movement, to minimize areas of friction or contact of tubing with a surface and so on, such as, a sleeve, a nut, a hollowed screw and so on.

Due to high cost of machining a mixer-settler spiral form as HDPE disks (herein, “disc,” disk,” and “plate,” are used interchangeably) and use of TEFLON® sheets (which are non-compressible) as gaskets, current rotors are prone to leaks, particularly at higher centrifuge speeds.

Thus, a mixer-settler rotor described in the '847 patent was redesigned and built with less expensive, more durable functional materials, for example, a durable plastic, to prevent leakage. TEFLON® sheets are a cold flow material and do not retain original thickness after being compressed. During and after use, a rotor needs to be retightened. However, it is difficult to retain a secure liquid seal. Hence, an improved gasket would be beneficial. For purposes herein, “septum,” gasket,” “sheet,” “washer,” and so on are used interchangeably.

In embodiments, each disc can be associated with two or three, or more, gaskets above and/or below in a rotor stack, as compared to a single gasket in the prior art. Hence, a rotor of interest includes at least two, at least three, at least four or more gaskets above and/or below a disc.

A mixer-settler spiral disk can comprise, for example, polycarbonate, polyoxymethylene and so on, fabricated by, for example, injection molding, and packed between softer, compressible sheets made of, for example, an elastomer (for example, about 0.035 inch thickness and coated with TEFLON® or a fluorinated ethylene propylene (FEP), such as, VITON® (VITON is a trademark of Chemours of Wilmington, DE and is a copolymer of hexafluoropropylene and vinylidene fluoride, terpolymers of tetrafluoroethylene, vinylidene fluoride and hexafluoropropylene, or perfluoromethylvinylether, which can be formed into membranes and other forms), an artificial rubber, a synthetic rubber and the like, that compress and regain original shaping when pressure, weight or any other compressible force is removed or reduced. Gaskets are available commercially and are provided in a variety of materials, of chemical resistance, of thickness, of hardness and so on, selection of which for use in CCC is a design choice. Thus, consideration is provided as to, for example, solvents used, to ensure a gasket material is not degraded by, is immune to, is not chemically reactive with and so on solvents used; a suitable thickness to ensure no leaks occur without adding much weight to a rotor stack; and so on.

Of plural gaskets, one or more may be of reduced diameter (as compared to a disc) and placed or situated about center screws and void of a rotor to minimize or to avoid fluid leak toward a central void, such as, a shaft, centrally situated in a rotor and a disc. Such a gasket may serve as a washer about a central void. A washer facilitates maintaining even and secure pressure with gaskets and a disc. That gasket can be made of a more rigid or stiff material, such as, acetate or TEFLON® with a thickness of about 0.01 in. A, “ring” (that term is used interchangeably with, “washer,” “gasket,” and so on) with fastener devices, such as, screw holes, as needed based on design, an example of which is shown as C in FIG. 6, may be placed with other gaskets to act as a washer and to prevent leaking in a central region of a disc, gasket and/or rotor. Again, such washer materials are available commercially and choice of composition, of thickness, of hardness and the like is a design choice to ensure no leaks occur without adding too much weight to a rotor stack; and so on.

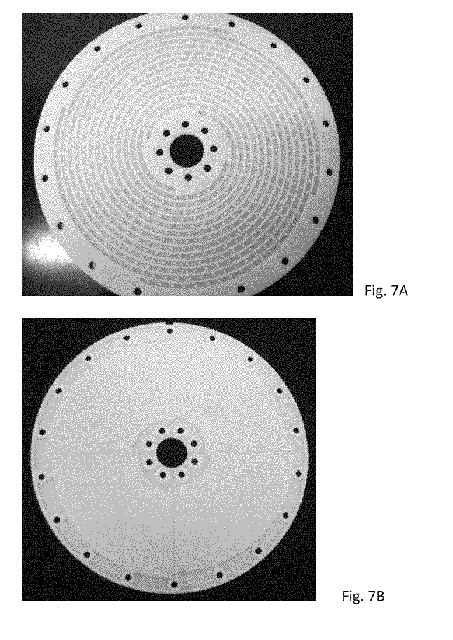

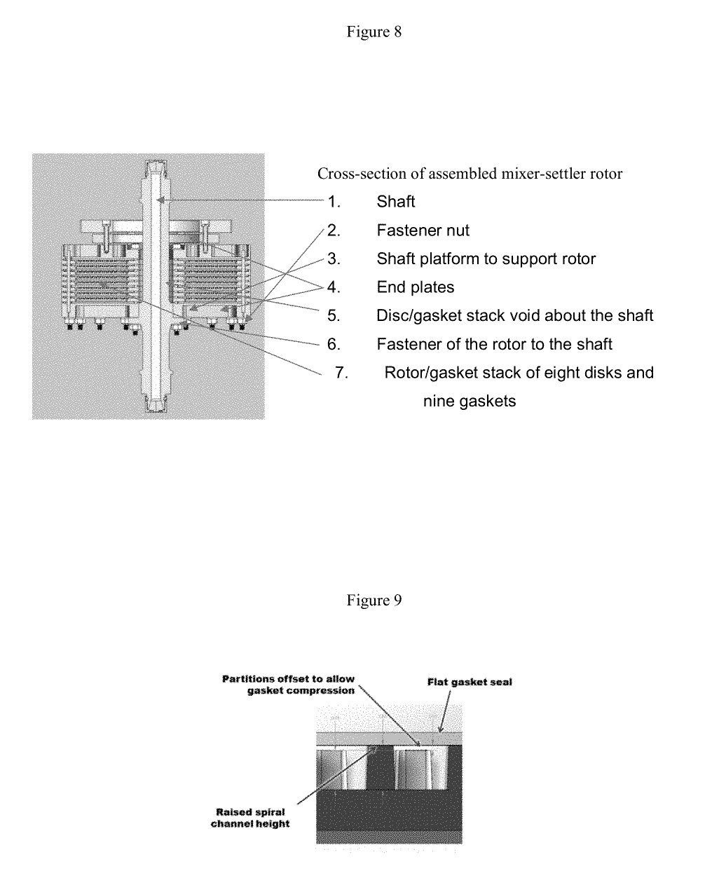

Full sized gaskets are constructed or selected to have a diameter less than that of a disc, the outer perimeter of a gasket fits within the outer hard stop, rim, lip, barrier and the like of a disc. The central void of a gasket has a perimeter that fits within or contacts the outer surface (distal, away from the shaft) of the inner hard stop of a disc. Hence, a gasket applied to a disc does not extend beyond the area bounded by the rims of a disk or the boundaries of a disc (FIG. 8).

Another gasket can comprise at least one radial slit, slot or channel, where a slit or channel marries with, is in register with, aligns with, complements, completes a void provided by a radial channel at an inferior surface of a disc and so on, so such a gasket does not constrict flow within a radial channel of a disc. A gasket can be made of any of the above materials and can have a thickness and the like as a design choice to ensure no leaks occur without adding too much weight to a rotor stack; and so on.

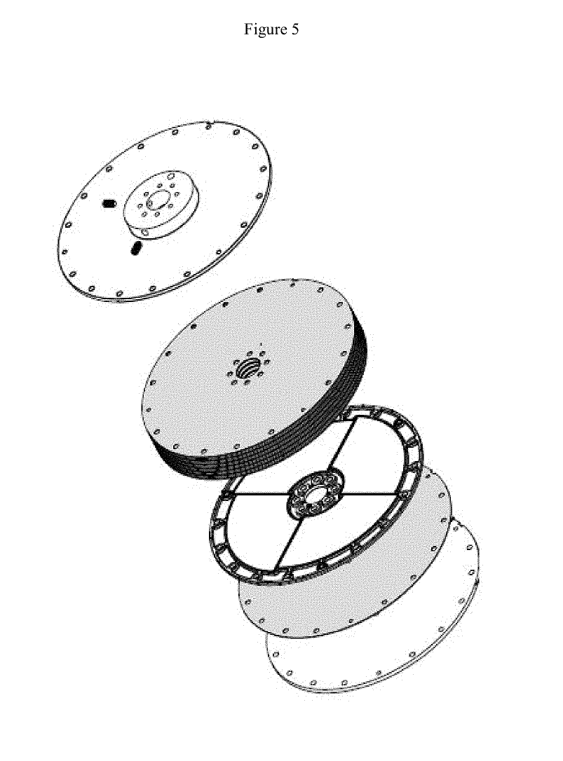

Thus, for example, a radial slit about 1 mm wide can be made on an inferior surface of a disc between a hole from end of a spiral on a surface above and start of a next spiral above to serve as a conduit for liquid flow between the spirals. Such a gasket is shown as B in FIG. 6. Below a washer (C) is a compressible full sized gasket (D of FIG. 6). Plates were stacked with gaskets and sandwiched between end flanges or plates. In FIG. 5 is depicted end plates for forming a rotor stack, the first and last structures of a stack that frame the sample separating discs, a stack of assembled discs, below is a gasket with radial channels and below that and above the bottom plate or flange is a compressible gasket. The side of an endplate opposite to that in contact with a gasket or a disk can be ribbed to provide strength, stiffness and the like without adding much weight, (FIG. 10).

The slitted gasket, washer and compressible gasket, B, C and D in FIG. 6, are novel in the art and constitute an improved set-up of components of a mixer-settler rotor for separating large molecules and for use with an ATPS system, which can be viscous. Improved containment of fluid in spiral plates allows for separation of larger molecules, such as, CNT's, using higher centrifuge speeds and so on.

In embodiments, each disc comprises a gasket thereon. Thus a gasket sits atop a disk with a gasket abutting, laying atop, contacting and so on the superior channeled surface of a disk. Hence, the gasket above the uppermost or first disc can contact an endplate. Alternatively, that gasket above the first or uppermost disc can contact another spacer, seal, separator, gasket and so on, in turn can contact another spacer, seal, separator, gasket and so on or the inferior surface of the top or superior endplate. The lowermost or last disc also can comprise therebelow a spacer, seal, separator, gasket and so on, which can contact a second spacer, seal, separator, gasket and so on or the superior surface of the bottom or inferior endplate.

In embodiments, an improved device for separation and purification of CNT's is a modification of a device described in the '847 patent. A rotor is made of stacked spiral grooved disks where solvent flows to separate molecules therein. A groove terminates in a hole that allows liquid to flow under a disc to a next interleaved spiral or to a next disk. In one type, there are four interleaved (interwoven) grooves, (channels are designed to course in alternating or non-adjacent grooves or layers) on and of a stackable disc, which at the end of each spiral, a channel underneath each disc courses fluid to beginning of a next spiral groove on an upper surface of a disc. Disks are sandwiched between gaskets or septa that keep fluid flow in a groove. Each disk is shaped as provided, for example, in FIG. 4A of the '847 patent. FIG. 4B of the '847 patent shows a cross-sectional view of a channel beneath spiral grooves. FIG. 4C is an underside view of the same disk with shape of a channel carved from an outer ending of a spiral groove to a center hole, 0, that goes through to a next disk. Flow goes through a hole, 84, in a septum or a gasket in FIG. 5. Plural disks and alternating septa are sandwiched between end plates or flanges pictured in FIGS. 6 and 7 of the '847 patent. Elements are depicted together in FIGS. 1 and 2.

Disks of the '847 patent were made of HDPE and were 5 mm thick. However, in light of the leaking issue discussed above, new discs were needed and designed.

Thinner disks that are durable, reduce weight, are not chemically reactive with solvents and are made of materials conducive to more cost effective construction methods, such as, injection molding, stereolithography, 3D printing and so on are described herein, Hence, discs can be made of, for example, polycarbonate, acrylonitrile butadiene styrene, a polyoxymethylene, such as, DELRIN® (a trademark of Chemours, Wilmington, Del., is a thermoplastic that can be formed in to a number of shapes), a polyphenolsulfone, an ultra high molecular weight polyethylene, any material used in a 3D printing process, such as, epoxy, ester and styrene compounds, and so on. Discs can be less than 5 mm in thickness, to minimize weight and overall weight of a stacked rotor. Diameter of discs is a design choice based on size of a planetary centrifuge, tubing used and so on.

A rotor of interest, being larger and having greater capacity, can comprise larger disc, more discs or both. Hence, as mentioned herein, a rotor and disc can be about 22.5 cm in diameter. Alternatively, a rotor can comprise 6 or more discs (along with a gasket thereon and any other gasket, seal or spacer), 7 or more, 8 or more, 9 or more, 10 or more, or more discs.

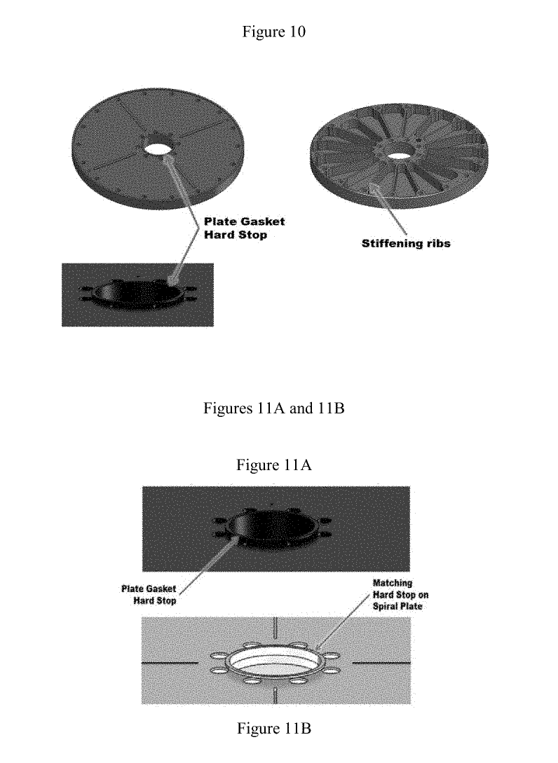

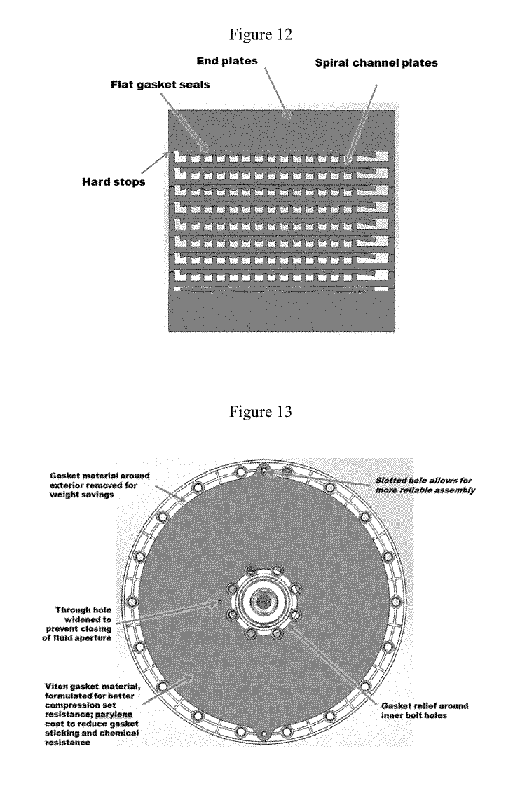

Discs can comprise a rim, a lip, a raised portion that describes a circumference of a disc, which may be discontinuous, a hard stop, a border, a levee, a ridge and so on about an outer perimeter and about a central void to provide better seating, a more snug fit, better sealing of a gasket to a disc, to minimize leakage, to prevent or to minimize expansion or bulging of a gasket beyond the perimeters and confines of a disc and so on (FIGS. 11A, 11B and 12). A rim can be at an inferior surface of a disc and/or at a superior surface of a disc. A radial channel on an inferior surface of disc is deeper than found in current discs and is 1 mm or greater in depth. Materials of a disc of interest, which are durable and light, enable narrower spiral channels increasing path length of a disc thereby increasing resolution of separation in a CCC process.

Discs are constructed so that walls of channels are of a height that provides conduits for tubing but also engages a gasket. Partition and radial channels that traverse spiral channels have a wall height less than that of the spiral channel walls and thus, without compression, do not engage a gasket that is laid on a disc, prior to sealing of a rotor, FIG. 9. The spaces formed by the lower radial channel and partition walls enable gasket expansion when the rotor stack is sealed and secured by fasteners, as needed, without breaching the inner void and the outer periphery of the rotor stack.

The interior void of a disc, and, of a gasket, also is of a size that avoids contact with the planetary shaft of the planetary centrifuge (FIGS. 2 and 8).

The centrifuge shaft also is constructed to comprise at a lower portion that engages the lower face of a rotor stack, a shelf, a ridge, a flared portion, an extension, an extrusion, pins and so on, of diameter greater than that of the centrifuge shaft. That shelf can have an extending size from one to several millimeters or inches depending on the size of the centrifuge to a size approximating the radius of a disc. The shelf can be continuous about the circumference of a shaft, or can be interrupted, with regular or irregular interruptions. The shelf can be of unitary construction of a shaft, that is, the shaft is formed to comprise a shelf. Alternatively, s shelf can be constructed to include a pin, a bar, a shelf, a stud and the like, appended or affixed to a shaft.

In embodiments, the rotor can be formed using a three-dimensional prototyping machine (3-D) printer). Examples of a machine that can be used to form the material for the design of the rotor frame include, but are not limited to a Sinterstation 2300 plus, Objet Geometries, Inc. Eden500V, or an EOS Precision.

The rotor frame securing a rotor in a centrifuge can be machined from a strong, yet light, material, such as, a metal, such as, aluminum; can be molded, such as, a ceramic; can be printed using a 3-D printer using suitable particulate starting materials and so on, as known in the art, and as a design choice.

The rotor frame is seated on a rotor shaft or spindle, for example, the planetary shaft, using suitable seating materials, lubricating material, shock absorbing material and so on, such as, a washer, spacer, wear pad and so on, of suitable composition to distribute load, dampen vibration, to serve as a bearing, to minimize wear, to minimize friction and so on. For example, a sealed bearing, which can be lubricated, is self-lubricated, is lubricated and sealed and so on can be used. The bearings can be circular, that is, balls, cylindrical and so on. The bearings can be affixed in a containing device to retain the bearings in place, that is, the bearings are sealed in place.

At movable joints of the shafts, sealed, pre-lubricated or self-lubricating roller bearings are employed, such as, at or in the juncture of the shaft and a shaft housing; at or in the juncture of a shaft and a shaft collar and so on. Such sealed bearings are suitable for high radial load and minimize angular misalignment at high speed. Increased rotor size and weight are better accommodated with such bearings.

Such devices provide a secure seating and connection of a rotor frame on a shaft, and enable free movement on the rotor frame about the shaft.

A rotor can be constructed so that the lower face of the rotor that engages, abuts, sits on and the like, a shelf of a shaft of interest, can comprise parts which engage complementary sites of the shelf, an accommodating void, such as, a rectangular void on an inferior rotor face in register with and which engages a protruding bar structure of a shaft. Such an engaging affixes a rotor to a shaft.

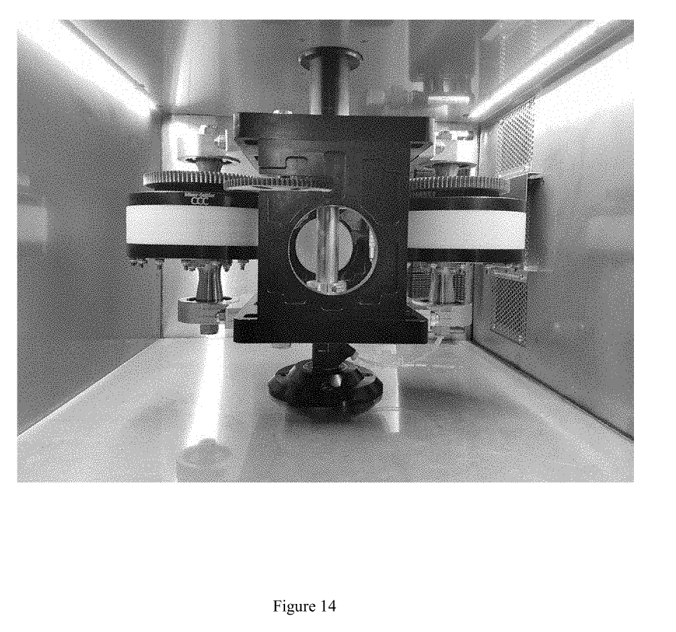

The planetary shaft also can be designed to comprise a flare in size that increases in diameter in the direction away from the rotor (FIG. 14) to provide greater support of the larger and heavier rotors.

Also, end plates (“end plates,” “end flanges,” “supporting plates,” and, “flanges,” are equivalent terms herein) of a new rotor were redesigned. Generally, flanges or end plates are made of a metal material. To balance strength of material to ensure firm and equal pressure is applied to components of a rotor stack, and rotor weight, end plates are designed to be of a thickness that ensures those goals are achieved. A top end plate comprises fastening devices, as well as fittings for seating in a centrifuge and for entrance of sample and solvent, and can be at least about 7 mm, at least about 7.2 mm, at least about 7.4 mm, at least about 7.6 mm, or more in height. A bottom end plate comprises fastening devices, as well as fittings for seating in a centrifuge and is at least about 4 mm, at least about 4.2 mm, at least about 4.4 mm, at least about 4.6 mm, or more in height. The outer face of the end plates, the face that is not in contact with a disc or gasket, can be hollowed and is ribbed, with any number of ribs, which may or may not have the same length, which may extend from the inner void to the outer perimeter, can be of uniform shape, can be tapered, can have any shape which provides strength and support of the end plate, while minimizing weight.

Hence, a new rotor of interest comprises newly sized end plates and new, thinner, plastic discs, with a rim or rims, radial channels of an inferior surface comprising a depth of 1 mm or greater, gaskets with a diameter less than that of a disc, protective structures at tubing egress and ingress at the rotor, discs and gaskets do not contact the centrifuge shaft and various other improves taught herein to obtain the goals mentioned hereinabove.

Thus, flow tubing was attached in a top and an out-flow tubing out a bottom of a rotor, disc or stack of discs. The input and output sites of tubing into a rotor are fortified, protected and so on to minimize tubing wear and damage as discussed hereinabove.

End plates, discs and gaskets were configured to accept and to accommodate screws and nuts to secure a stack of disks and gaskets. Screws are tightened evenly and incrementally around a center and an outer perimeter, optionally, in an alternating or opposing order for even tightening and to obtain an even seal across a face of a rotor. Screws are tightened partially, alternatively and evenly around a central region and an outer perimeter to provide a uniform seal with gaskets without distorting or deforming gasket shape, to form an even seating of disc, gasket and rotor. Using such an assembly, liquid flow was obtained at up to about 1 ml/min at high centrifuge speeds with no leaks.

As a result of those improvements, a mixer-settler CCC rotor can be adapted for use at higher speeds, for use with thicker solvents and for use with samples of higher molecular weight by using new gasketing; using new washers, using new discs, using new end plates and so on in a rotor of interest that is lighter than prior art rotors; and using a shelfed shaft to support a rotor, to separate large molecules. Thus, there are no leaks when all discs, gaskets and washer are ordered and an assembly is tightened, for an even seal around and about a rotor; or new discs in a new rotor are used to form a rotor stack, again with an even seal about discs that enable use at higher centrifuge speed for separating larger molecules.

With a CCC rotor of interest, protein analytical and preparative separations are possible with ATPS systems. As an ATPS system, the general diluent is water. Hence, water is a primary vehicle for stationary and mobile phases.

Complete recovery of samples is possible and/or baseline separations can be developed for any protein mix or mix of larger molecules, including CNT's. Suitable solutes for forming the two phases include polyethylene glycol (PEG), for example, having a size from about 6,000 to about 10,000 MW, and dextran, for example, having a size from about 60,000 to 90,000 MW.

Polymer solutes can be present in phases or in originating solutions in an amount from about 0.1 wt % to 95 wt %, based on weight. A weight or volume ratio of the first polymer solution to the second polymer solution prepared separately and then combined can be from about 1:100 to about 100:1.

For example, a 10% by weight solution of 8,000 MW PEG in water and a 16% by weight solution of 75,000 MW dextran in water can be used. When combined in a 3:2 volume:volume ratio of the PEG solution to the dextran solution, two phases result on standing. That total 3:2 mixture comprises 6% PEG and 6.4% dextran. Those two phases can be used in a CCC rotor of interest forming mobile and stationary phases.

A solute, such as, PEG or dextran, can be derivatized or substituted with one or more chemical groups, which derivatives can be purchased commercially or produced practicing known methods. Substitutions can include a compound or a radical substituted with at least one substituent independently selected from, for example, a halide, a hydroxyl, an alkoxy, a nitro, an amino, a carbonyl, a thiol, an ester, a carboxyl, a salt, an alkyl, an aryl, an arylalkyl, a heteroalkyl, a heteroaryl, a cycloalkyl and so on, or a combination thereof.

Surfactants are included in a diluent or solvent, such as, sodium dodecyl sulfate (SDS) or other sulfates, sodium cholate (SC), sodium deoxycholate (SDC) and the like. Surfactants also may be present in CNT preparations to assist in dispersing particles in solution. Amount of a surfactant is a design choice to facilitate suspension and separation. A surfactant also can be used to form a gradient in a separation.

Thus, CNT's may have a surfactant, detergent or dispersant (equivalent terms) disposed therewith, generally on an external surface of a CNT. A dispersant may stabilize a CNT preparation and may aid fractionating of CNT populations during separation. A dispersant can be present on CNT's in an amount effective to form a colloid or to be dispersed in a solvent, diluent or phase.

In embodiments, a dispersant includes a polyether, a sulfate or a sulfonate (e.g., SDS and sodium dodecyl benzene sulfonate), a bile salt, a polyvinyl pyrrolidone or combination thereof.

Examples of bile salts include a salt (such as, a sodium or potassium salt) of a conjugated or unconjugated cholate or cholate derivative including, deoxycholates and the like.

A surfactant can be ionic or nonionic, where ionic surfactants include anionic, cationic or amphoteric surfactants. Surfactants often are amphiphilic. Examples of cationic surfactants include alkylamine salts, quaternary ammonium salts, and the like. Examples of amphoteric surfactants include amine oxides. Examples of anionic surfactants include alkylbenzene sulfonates, such as, dodecylbenzene sulfonate and dodecylphenyl ether sulfonates.

As a rotor of interest separates larger molecules, molecules, such as, single-wall carbon nanotubes (SWCNT's) can be separated [22]. Semi-conducting CNT's bind to polysaccharides and can be separated from metallic CNT's in agarose columns by elution with certain anionic detergents [17] as known in the art. In embodiments using a PEG and dextran ATPS system, semi-conducting CNT's bind to or are located preferentially with dextran in an SP and are separated from metallic CNT's which have high partitioning in a PEG-rich MP and are eluted generally earlier.

CNT's are a carbon allotrope, a derivatized carbon allotrope or combination thereof.

CNT's generally have an average particle size of less than about 1 μm. CNT's are measured as known in the art, for example, by static or dynamic light scattering; ultraviolet, visible or fluorescence spectroscopy; atomic force microscopy; and so on. CNT's can have an average particle size of about 250 nm or less, although for purposes herein, actual size is a design choice as a focus is separation of populations of common property or properties.

Carbon nanomaterials include fullerenes, graphenes and CNT's, which comprise SWCNT's, double-walled CNT's (DWCNT), multi-walled CNT's (MWCNT) and so on, and for purposes herein, CNT is meant to include any carbon allotrope.

Fullerenes include cage-like, hollow forms of carbon possessing a polyhedral structure with, for example, from about 20 to about 100 carbon atoms. For example, C₆₀ (buckminsterfullerene) has 60 carbon atoms with high symmetry.

Nanotubes include carbon nanotubes, metallated nanotubes and so on. Nanotubes have open or closed ends. In embodiments, nanotubes include additional components, such as, metals or metalloids, which can be incorporated into the structure of the nanotube, can comprise a surface coating or both.

CNT's can have one of several geometrical arrangements as to a lattice of carbon atoms. For example, SWCNT's can be distinguished by double vector indices (n,m), where n and m are integers that describe geometry and configuration of carbon atoms and component molecular structure of a nanotube. “Arm-chair,” SWNCT's are (n,n), when a nanotube is cut perpendicularly to tube axis, only sides of hexagons are exposed, and the pattern around a periphery of a tube edge resembles an arm and seat of an arm chair repeated n times. When (n,m=0), an SWCNT is, “zigzag,” and for (n,0), when a tube is cut perpendicular to a tube axis, atoms located at an edge of a tube have a zigzag arrangement. When n is not equal to in and not equal to 0, an SWCNT is chiral.

Electronic properties of SWCNT's can be dependent on configuration. Thus, SWCNT's can have different electronic signatures for different conformations. Consequently, SWCNT's are metallic (electrically conductive) or are semiconducting (comprising a bandgap from about a few meV to about 1 eV.) Generally, for n=m or n-m is a multiple of three, an SWCNT is metallic and for other n,m combinations, an SWCNT is semiconducting. Accordingly, armchair nanotubes are metallic and have higher electrical conductivity.

Carbon atoms in a CNT can be displaced or substituted by another element practicing known materials and methods. Hence, a CNT can include an oxide, such as, silica, alumina, titanium, tungsten oxide, iron oxide and the like, a carbide, such as, tungsten carbide, silicon carbide and the like; a nitride, such as, titanium nitride, boron nitride, silicon nitride and the like; or combination thereof. CNT's can include an alkali metal, an alkaline earth metal, an inner transition metal (a lanthanide or actinide), a transition metal and so on. Such metals can coat a CNT. A CNT can be attached covalently to a pharmaceutically active compound and used for drug delivery.

CNT's can be made by a known method including chemical vapor deposition, such as, high-pressure carbon monoxide conversion (HiPco), laser ablation, arc discharge, a specific catalytic processes, such as, CoMoCAT (Chasm Advanced Materials, OK) and so on. CNT's also are available commercially. It is known many such synthetic methods produce a variety of species, such as, size, chirality, n,m dimension and so on.

In CCC, CNT's can be present in an MP or in a retrieved fraction in an amount from 0.1 wt % to 95 wt % based on weight. A concentration of MP polymer, SP polymer and sample load are selected to maximize resolution of a populations of particles or molecules.

In embodiments, a ratio of a volume of MP to SP can be from about 0.01:100 to about 100:0.01.

CNT's can be separated into chiral species by applying an ATPS system in a mixer-settler CCC of interest.

Because CNT's are available commercially, CNT's can be provided, for example, as a suspension or a powder. Each preparation contains reagents desired and used by a manufacturer. Hence, a CNT may be dispersed in a micelle, with a detergent, such as, an anionic detergent, or can be bound to a solid support, such as, an agarose bead. CNT's can be removed from agarose beads by exposure to SC or SDC. But, some solutes can impact CNT structure, property and behavior in a solvent and in a chromatographic separation. Thus, it is desirable to have CNT's suspended in a solution for use in CCC.

An extraction method was developed for CNT's using an ATPS system of PEG and dextran [19], with combinations of detergents that enable CCC separation of semiconducting from metallic CNT's from mixtures of CNT's of similar diameter. Partition coefficients (K) of individual CNT's could be measured by spectroscopy, UV, fluorescence and Raman spectroscopy [18].

Hence, for example, an aliquot of powder, such as, about 10 mg in an experimental chromatographic run, can be mixed with a 1:1 v/v mixture of SC and SDC as a dispersant solution and to standardize solutes used for CCC. For example, that 10 mg sample can be mixed with about 0.5 ml of SC and about 0.5 ml of SDC. SC and SDC solutions can be prepared as 5% w/w stock solutions. The CNT dispersion then is sonicated, for example, with a probe, three times at 20 sec each to suspend CNT's in that detergent solution. The mixture is centrifuged and an aliquot, such as, about 250 μl, is added to about 3 ml of UP and 3 ml of LP (SS #1 in Table 1), which represent solvents useful in CCC. Particular UP and LP can comprise PEG and dextran, and SDS as a surfactant that forms a gradient in a chromatography. The preparation is mixed and allowed to settle into two phases. UP is removed and an additional 1 ml of UP is added and mixed, and that preparation then is used as a sample for a CCC run. By that method, CNT's are exposed to known surfactants, are washed and are suspended in a solvent that will be used directly in a CCC run. Centrifuge is turned on and mobile UP phase is introduced after sample, at a rate, for example, of about 0.5 ml/min, to produce an SDS gradient in the PEG-rich UP.

New gaskets, washers, discs and rotors can be operated at a speed and at an MP fluid flow rate as design choices, for example, which provide maximal separation of molecules. Hence, a flow rate can be about 0.25 ml/min or more, about 0.5 ml/min or more, about 0.75 ml/min or more, about 1 ml/min or more, or greater. A centrifuge can be operated at a speed of about 700 rpm or more, about 800 rpm or more, about 1000 rpm or more, about 1200 rpm, or faster.

Improved mixer-settler spiral disk rotor designs of interest enable a means to chromatograph CNT's in an automated system. A laboratory instrument system can consist of a planet centrifuge with one or more mixer-settler rotors, each comprising two or more discs, with gaskets as needed or as a design choice, a gradient pump, sample loading valve, fraction col lector and a system controller via computer or mobile phone app. Time of a run, with settings of rpm, pump solvent delivery gradient and flow rates, automatic sample injection and fraction collection time can be programmed as a design choice. Rotor and components of interest provide a new useful separation means for materials of the nanotechnology market.

After fractionating a composition (e.g., after a single run of a process above), separated particles may be included in more than one phase, even if in an amount that is not readily detectable. Using a, for example, PEG/dextran, ATPS system, semi-conducting CNT's are in LP. (To alleviate presence of CNT's in both phases, a fraction could be used in a second run of a separation process of interest, and so on, until a pure population of a particular CNT is obtained but that would require removal of SDS which was used to form the discriminating gradient.) That could result in a population with a purity of about 100%, greater than or equal to about 50%, greater than or equal to about 75%, greater than or equal to about 85%, or greater or more pure. By, “about,” herein is meant a metric that can vary up to 05% from a stated value, but no greater than an absolute, for example, about 100% cannot exceed 100%.

A fraction or a separated mixture is removed from a rotor and can be subjected to further processing, such as, removal of solute, surfactant, replacement of diluent and so on, practicing known methods, such as, dilution, washing, centrifugation, evaporation and so on to obtain a purified preparation of a CNT population.

A goal of the materials and methods of interest is to obtain a pure population of a CNT, based on a difference of a property between or among populations of particles in a starting sample, such as, metal chirality, shape, size, diameter, length, handedness and so on.

Materials for making a rotor or disc of interest are provided, for example, in the '847 patent; components can be machined; or components, such as, discs or rotors, can be purchased, for example, from CC Biotech (Rockville, Md.), Planetary centrifuges can be made as known in the art or can be purchased.

The invention now will be exemplified in the following non-limiting examples.

### EXAMPLES

### Example 1

A prior art mixer-settler spiral disk rotor, was disassembled for parts. Fluid flow had become blocked after use.

On inspection, the plastic plate or disc was found to have too shallow a return channel underneath, the depth was observed to be less than 1 mm. The soft gasket below the disc had filled the space in the channel and blocked fluid flow.

### Example 2

After the rotor of Example 1 was used for about 3 months, leaking was observed through the center towards the shaft.

It was discerned that screws around the center had been overtightened resulted in breakage of some screws. Gaskets revealed solvent leaked around the screws in the center area, plates and gaskets were not sealed well.

Screw holes of the bottom end plate were reamed so screws could be tightened without pressure on the screws and on the substance of the bottom end plate, the threads and screw holes. The screws were associated instead with nuts for tightening and a more decentralized pressure on the bottom plate.

### Example 3

An assembled rotor with a new gasket below a disc where radial slits in the gasket marry with channels in a disc, also included compressible VITON® gaskets. A smaller gasket or washer of interest about the central portions of a rotor minimized or prevented leaking.

A mixer-settler spiral disk with gasketing can be used to separate large molecules, such as, proteins as well as separation of species of CNT's using an ATPS system.

### Example 4

### SWCNT's in an ATPS System

Single and multi-step extractions with an ATPS system in CCC containing anionic detergents produced separation of semi-conducting CNT's from metallic CNT's in mixes of larger diameter or of small diameter CNT's. Various species of CNT's displayed different K depending on diameter.

A solvent system consisted of PEG (MW=6,000-8,000) and dextran (MW=around 75,000 from Leuconostoc mesenteroides). Concentration of SC and of SDC is adjusted to modify K of particular species of CNT's as measured by fluorescence. For example, 0.27% SC and 0.21% SDS up to 0.81% SC and 0.63% SDS in a solvent system have semi-conducting CNT's in an UP with increasing K and metallic CNT's in an LP also with increasing K Thus, two classes of CNT's are fractionated with gradients of surfactants [18].

Metallic CNT's elute early with the PEG upper mobile phase and semiconducting CNT's are retained in the dextran lower stationary phase and elute later. Fractions can be collected and different CNT's eluted depending on hydrophobicity of micelles of nanotubes with different shape.

### Example 5

### Gradients

Gradients can be evaluated initially by measuring partitioning at onset of separation and after separation is completed. Increasing or decreasing pH gradients can be made, for example, with glacial acetic acid, triethylamine or cyclohexylamine, from pH 4 to 8, for example. Bases that do not cause UV interference can be useful. Another approach is to vary surfactants or to have a surfactant gradient for selectivity.

### Example 6

### Modification of a Polymer

Modification of an LP polymer, dextran, can be done by reaction with diphenyl carbamyl chloride which couples to hydroxyls [20]. After reaction, a polymer can be dialyzed to remove reagents and either used directly or freeze-dried and a, for example, 15% aqueous solution prepared. Aromatic groups added interact with SWCNT walls and micellar surfaces to change elution pattern.

Other modifications of dextran include coupling to other molecules that influence elution of micellar CNT's.

### Example 7

### Solvent Systems

Solvent system components are mixed to form two phases and a volume of each phase is taken and combined with CNT's. The solution is agitated and phases allowed to separate. Concentration of nanotubes in each phase is measured by, for example, fluorescence spectroscopy. Solvent systems giving different values of K are selected for separation experiments. Also, solvents that reveal differences between metallic and semi-conducting CNT's are considered. K can be used to provide a ratio of upper to lower phase (Cᵤ/Cₗ), C is concentration. In CCC, K from a run is an SP to an MP ratio (Cₛ/Cₘ) which can be calculated from elution volumes. At K=1, a compound elutes at a column volume which is total volume of flow path excluding amounts in flow tubings. A phase chosen as an MP is that giving a K closer to 1. Elution volumes from about 0.3 to about 2 comprise a zone of maximal resolution. K_{s/m} (SP/MP) calculated from elution of a compound is ratio of elution volume of the chromatographic peak (p) minus excluded volume of the column/rotor (m) to the total volume of the column/rotor (c) minus excluded volume of the column/rotor.

K=(Vₚ−Vₘ)/(V_{c}−Vₘ)

For analysis of sample mixtures, efficiency of separation can be determined by use of the conventional gas chromatographic equation [21]:

N=(4R/W)²

Theoretical plates, TP or N, are calculated from shape of peaks. R is retention volume of a peak maximum and W is peak width expressed in the same units as that of R. For preparative separations, N may be up to 1000, but a more important relationship is resolution. Resolution between adjacent peaks is given by, where R values are retention volumes of the two species or populations:

R_{S}=2(V_{R2}−V_{R1})/(W₁+W₂)

Using that equation and substituting each solute retention volume by the following:

V_{R}=Vₘ+KV_{S}

where Vₘ cancels giving:

R_{S}=2(K₂−K₁)Vₛ/(W₁+W₂).

Thus, resolution is proportional to Vₛ and difference between K's. From high Vₛ typical of CCC, high resolution is possible even with low N values, which can be <1000.

Stationary phase (S_{F}) retention measurement is done by filling a rotor with SP, beginning centrifugation and then pumping MP through at a flow rate appropriate for a rotor and solvent system, usually at about 0.5 ml/min. When solvent front comes through, excluded SP represents excluded volume, Vₘ. Subtracting Vₘ from total column volume, V_{c}, yields SP volume, Vₛ. Phase retention is ratio of SP volume to total volume, Vₛ/V_{c}. High S_{F} values above 50% for polar and ATPS solvent systems have been achieved with the rotors of interest.

### Example 8

Methods, such as, chemical vapor deposition, HiPco and CoMoCAT, produce different compositions or forms of SWCNT's. Dispersions produced may have more amounts of large diameter CNT s than small diameter CNT's, for example.

### Example 9

Dextran (MW 75,000), SC, SDC, SDS and PEG (MW 8,000) were obtained from Fisher Scientific (Boston, MA) or Spectrum Chemical (Gardena, Calif.); and CNT dispersion of 6.5i in 0.2% SDC was obtained from SouthWest NanoTechnologies Inc. (Norman, Okla.). A sample of 6.5i powder from the same manufacturer also was used. Water was purified in a Neu-Ion system (Baltimore, Md.) or HPLC water was obtained from Fisher Scientific.

A planetary centrifuge (CentriChrom, Inc. Buffalo, N.Y.) was mounted with one mixer-settler rotor (17.5 cm OD, cat. no. 205-10001, CC Biotech, Rockville, Md.), Some experiments were performed with a rotor made of stacked polycarbonate disks. Each disk had four interleaved spirals and flow goes through serially, then to a next disk. A flow channel groove in a disk has mixing and settling sections with a glass bead in every fourth section. Total volume in a rotor with six layers or discs is 84 ml. Some separations were conducted with a rotor comprising different number of discs, such as, five or seven layers or discs.

As noted in Examples 1 and 2, there were difficulties with leaking using prior art rotors. Hence, another gasket was designed containing radial slits in register with radial channels at a lower surface of a disc, to maintain or to space a sealing gasket and to allow unimpeded liquid flow. Also, a washer or gasket can be used about central portions of a disc.

CNT's were separated successfully using that rotor and gasket set up.

### Example 10

Another rotor was machined with metal top and bottom base plates that contained ribs that ran the radius of the base plate and were tapered and of a lower height toward the outer periphery on the surface not in contact with disc or gasket (the outer face of a stack) to apply more secure and more even pressure on plastic disks around an entire surface of a rotor sandwich without contributing too much weight to the final rotor, see, for example, Example 2. A mixer-settler disk had deepened radial channels on a lower or interior face of a disc to minimize interruption of flow. Segment divisions or pins in flow channels were placed straight and at a height lower than channel walls. A disc was fabricated by stereolithography with an epoxy resin (SOMOS® NeXt, DMS, Elgin, Ill.) with wet-dry blast surface treatment. A top or superior surface (FIG. 7A) contains four interleaved channels with retaining pins defining segments to secure a glass bead. A bottom, underside, lower surface or inferior surface (FIG. 7B) comprises radial channels connecting one spiral to a next spiral on the top surface, or to a hole leading to a next disc below or out of a rotor. The central void of the discs and gaskets are slightly greater in size than the diameter of the centrifuge shaft The disc contain rims around the interior void and all the outer perimeter. The gaskets are seated within the rims. Photos presented in FIGS. 7A and 7B are not the same scale. Volume of six layers of discs was around eighty ml. Holes in disks and gaskets were slightly widened as well.

Polytetrafluoroethylene (PTFE, TEFLON®) flow tubing, 1/32 in inside diameter (ID) (Zeus Industrial Products, Orangeburg, S.C.) was connected to a top flange (metal plate or end plate) with a metal nut (compression screw with a stainless steel flange and plastic ring (Idea Health and Science, Chicago, Ill.)) and passed into a rotor shaft and out a bottom into a central axis. Another flow tubing connected to a bottom end plate outlet also went into a rotor shaft and out an open end with other flow tubing into a central axis. Both tubes are inside a larger ID TYGON protective tubing containing some lubricating grease. Flow tubing passes out a top of a centrifuge and is clamped to prevent twisting. A rotor arm is counterbalanced with metal rings equal in weight to a mixer-settler rotor (which was balanced with, for example, weights, screws, nuts and so on), placed at same height and same distance from the center axis of the centrifuge.

Solvent is pumped from a gradient dual pump system (D-Star Instruments, Manassas, Va., controlled with Clarity software). Flow passes in a pump through a manifold with a 10 ml sample loop valve and another valve with helium for clearing rotor contents. Solvent flow then is connected to an in-flow tubing of a CCC instrument. Outflow from an instrument central axis goes to a fraction collector (Pharmacia or Bio-Rad).

Performance improved, with lower back pressure, no difficulty with air bubbles forming and no leaks.

An ATPS system of PEG MW 8,000 and dextran MW 75,000 (DEX) containing SDC was used. A gradient of SDS from 0 to 0.7% in the upper PEG-rich phase as MP served to elute CNT's in the chromatography. Prior to use in CCC, volumes of stock solutions (see Table 1) were mixed in a separatory funnel and phases separated after about 45 min with about 351 ml in the upper phase (UP) and about 129 ml in the lower phase (LP) for SS #1.

TABLE 1
Preparation of the solvent systems for sample and
gradient spiral countercurrent chromatography

| | | | | Sample pre-load | |
|---|---|---|---|---|---|
| Stock solutions | Solvent system #1 | | | extraction | |
| by weight g/g | (SS #1) | SS #2 | | SS #3 | SS #4 |
| PEG 10% | 300 ml | 300 | ml | 4 ml | |
| DEX 16% | 200 ml | 200 | ml | 2.5 ml | 2.5 ml |
| SDC 10% | 1 ml | 1 | ml | | |
| SDS | | 3.5 | g | | |
| PEG 14% | | | | | 4 ml |

For sample preparation, a stock 1% by weight of CNT powder in solution was sonicated with a probe three times for 20 sec each. Thus, a suspension of about 10 mg of CNT's in about 0.5 ml of about 5% SC and about 0.5 ml of about 5% SDC was sonicated and 0.25 ml was removed and added to 3 ml of UP SS #1 and to 3 ml LP SS #1. The mixture was vortexed and allowed to settle into two phases. UP is removed and 1 ml of UP SS #1 was added to the CNT UP solution and the total was loaded into a CCC rotor as a 2.5 mg sample load.

CNT dispersions or suspensions provided by others were extracted according to a previously published method using SS #3 and SS #4 described in Table 1. A 0.5 ml or 1 ml amount of a CNT dispersion (approximately 0.1% of 6.5i CNT's in 0.2% SDC) is extracted and loaded through a sample loop valve. Sample prep was done by combining about 0.5 ml CNT's with about 0.5 ml of about 10% SC to 4 ml UP SS #3 and about 0.5 ml LP SS #3, the mixtures were vortexed and then centrifuged at 1000 rpm for 1 min. UP is removed and to that was added 1 ml UP #3 and all is loaded into a centrifuge.

A rotor is filled with LP at a rate of 0.5 ml/min. Sample is loaded in a 10 ml loop; centrifuge is set to about 990 to about 1000 rpm, sample is injected and UP #1 pumped with allow of about 0.5 ml/min. A gradient is started when all of sample is in the spinning rotor. A gradient of UP #1 A to UP #2 B is made over an 8 hr period for a 5 layer rotor (Table 2). Fractions are collected every eight min. Elution mode=U o H (U=upper phase; o=outer entry, bottom in CCW rotation; H=head to tail end of column/rotor, which means sample and mobile upper phase flow entered through the bottom of the rotor in head to tail direction)

TABLE 2
Gradient conditions for CNT separation
Stationary phase = LP SS #1;
Mobile phase A = UP SS #1 B = UP SS #2

| Rotor | Conditions | | Type of gradient |
|---|---|---|---|
| 5 layer mixer-settler | 0 to 100% B | | 480 min linear gradient |
| disks | | | |
| 7 layer mixer-settler | 0 to 100% B | | 660 min linear gradient |
| disks | | | |
| 6 layer mixer-settler | 0 to 100% B | | 540 min linear gradient |
| disks | | | |
| See paragraph 90 | | | |
| 7 layer mixer-settler | 0 min | 0% B | convex gradient |
| disks | 220 min | 50% B | |
| | 440 min | 80% B | |
| | 660 min | 100% B | |

Generally a 0.5 ml aliquot is taken from a vortexed fraction to include both phases and 0.5 ml 2% aq. SDS was added to dissolve all phases and to make a clear solution. Absorbance at two wavelengths is read with water as blank in a Cary 3E VC-Vis Spectrophotometer (Varian, Santa Clara, Calif.). Absorbance of fractions is plotted. Fractions containing black solids (soot) or dark solutions and colors are noted. When enough concentrated fractions were achieved in CCC runs, spectra were measured from 240 to 900 nm to analyze peaks of chiral species.

Fractions containing color were assessed for semiconductor activity in a polybrene impedance assay.

For characterization of a spiral CCC process, CNT's from SouthWest Nanotechnologies composed of mostly 6.5 chiral species with a range of lengths was used as a sample. The 0.1% CNT's in 0.2% SDC dispersion was dark, mostly black, with some passage of light. One ml of an extracted solution was loaded, where the original preparation was extracted as described above, but with extraction SS #4 made with 14% PEG (Table 1).

That set up results in CNT's in LP in a solution, not packed particles. Of each extract, 0.5 ml of LP were combined and loaded. Solvent front where excluded SP elutes was at fraction 9, or about 34.9 ml, meaning SP retention was about 59%, a high amount for ATPS. After solvent front, fractions were gray in the UP and clear fractions followed until fractions 39-41; light green, then darker green-purple at fractions 42 and 43; 44 is purple; and then samples were purple-grey until fraction 50. Colored fractions emerged at 35 to 40% B in the gradient. After chromatography, cloudy fractions separated into two phases with color in the LP, which contain separated CNT's.

The following run was with 2 ml CNT solution and 1 ml 10% SC and 2 ml LP #1 which was sonicated and the entire sample was loaded. A convex gradient (Table 2) was run. After solvent front, fractions were grey and strong UV absorbance (used to track compounds comprising aromatic moieties) was measured. (In the sample prep, UP was not separated. Therefore, a large peak after solvent front was present. In most other runs, UP was removed and fresh UP SS #1 was added. That removed a large UV peak after solvent front.) Green fractions are noted at fraction 47 and purple starting at 50 until 56. That run had two times more material than a previous run and subsequent runs with different extractions and more volume resembled the run with green fractions followed by purple fractions. Colored fractions had semiconductor activity in field effect transistors.

Impurities were removed as revealed by soot and dark colors in a UP at solvent front and more dark particles were in an SP left in a rotor, which was eluted after pump out. After chromatography runs, a rotor is flushed with many column volumes of water to remove SDS. Green fractions followed by purple fractions were 6.5 chiral species, the major type (based on composition of the starting sample and measured spectra of fractions), which were removed from a chiral type of green color.

### Example 11

Materials and methods of Example 10 were practiced, except a different starting CNT preparation was used.

Powder from SouthWest NanoTechnologies, SWeNT® SG 6.5i-L43 was suspended at 10 mg/ml and sonicated as described in Example 10. About 250 μl were added to SS #1, 3 ml of each phase as described were used, mixtures shakened and allowed to form phases, UP was removed and 1 ml UP added and the total loaded. A linear gradient from 0 to 100% B was run at 0.5 ml/min over 540 min in a new mixer-settler rotor with 6 layers, third entry of Table 2. Fractions after solvent front had gray UP and black fluffy precipitate at the interface and comprised a high UV peak. That was followed by clear fractions, two pink fractions, followed by clear fractions then light blue fractions, a fraction that was dark yellow or green then purple fractions. Colors were bright and concentrated enough to provide spectra. The experiment was repeated with identical results.

From spectral analyses, purple fractions are the major chiral species of 6.5 and light blue fractions can be 7.6 or 7.3, which have close spectral peak maxima. CNT's with surfactants bind dextran in SP that elute as reverse micelles. On standing, those fractions separate into two phases with CNT's in LP.

### Example 12

The materials and methods of Example 10 were practiced, except a different starting CNT preparation was used.

Separations of CNT powders provided by other suppliers were conducted in a rotor with slitted gaskets and washers; and with a new rotor with thicker upper and lower plates as described in Example 10. Samples of dispersions and of powders suspended in solvent, washed and extracted as described in Example 10 were prepared and separated.

Separation of CNT's was obtained with either rotor.

CCC using gaskets and washer of interest with prior art discs and rotors; using an ATPS system comprising PEG and dextran; or using a newly machined rotor with thicker flanges and improved fasteners, and manufactured discs with deeper radial channels separates chiral species of CNT's.

### Example 13

A scaled centrifuge with a revolution radius of 13 cm was constructed. The planetary shaft was lipped, and flared at both ends. The increased size enabled a larger rotor, with larger discs and gaskets to increase fluid volume in the rotor. Rotor endplates were ribbed and contained protective sleeves for tubing entry and exit. Discs had channel walls and partition walls of heights as described herein, that is, channel wall were taller than partition walls. Discs contained an outer an inner lip or rim near the outside perimeter of a disc and at the central void of a disk.

The rotor stack was assembled with discs and gaskets fitted thereon and therein. The rotor stack was secured by fasteners and then seated and secured to the planetary shaft.

The centrifuge was operated at speeds up to 1000 rpm, with pressures up to 100 psi, without leakage.

All references cited herein, each herein is incorporated by reference in entirety.

Various modifications and changes can be made to the teachings herein without departing from the spirit and scope of the subject matter disclosed herein.

The instant application claims benefit from U.S. Ser. No. 62/533,428 which comprises as a supplement or exhibit the Invention Disclosure form of the instant invention, and the total disclosure of that provisional application is incorporated herein by reference in entirety.

### REFERENCES

1. Hersam, M. C. Progress towards monodisperse single-walled carbon nanotubes, Nature Nanotech. 3 (2008) 387-394.
2. Ghosh, S, Bachilo, S. M., Weisman, R. B. Advanced sorting of single-walled carbon nanotubes by nonlinear density-gradient ultracentrifugation, Nature Nanotech. May 9, 2010 DOI: 10.1038/NNANO.2010.68.
3. Bollard, J. M., Stora, T. Salvetat, J. P., Maier, F. Stockli, T. Duschl, C., Forro, L, deHeer, W. A, Chatelain, D. Purification and Size-Selection of Carbon Nanotubes, Adv. Mater. (1997) 9:827-831.
4. Zheng, M. Jagota, A., Strano, M. S., Santos, A. P., Barone, P., Chou, G., Diner, B. A., Dresselhaus, M. S. Mclean, Onoa, G. B, Samsonidze, G. G., Semke, E. D., Usrey, M., Walls, D. J. Structure-based carbon nanotube sorting by sequence dependent DNA assembly. Science 302, 1545-1548 (2003).
5. Doom, S. K, Strano, M. S. O'Connell, M. J., Haroz, E. H., Rialou, K. L., Hauge, R. H., Smalley, R. E., Capillary Electrophoresis Separations of Bundled and Individual Carbon Nanotubes J. Phys. Chem. B 2003, 107, 6063-6069.
6. Lukaszczuk, P. Rummeli, M. H., Knupfer, M. Kalenczuk, R. J., Borowiak-Palen, E., Surfactant free fractions of metallic and semiconducting single-walled carbon nanotubes via optimised gel chromatography, Materials Research Bulletin 47 (2012) 687-691.
7. Alidori, S., Londero, P., Bergkvist, M., Scheinberg, D. A., Mc Devitt, M. R., Deploying RNA and DNA with Functionalized Carbon Nanotubes. J. Phys. Chem. C 2013, 117, 5982-5992.
8. Ito, Y. (2005) “Instrumentation for Countercurrent Chromatography”, Ewing's Analytical Instrumentation Handbook, 3^{rd} ed. J. Cazes, ed. Marcel Dekker, New York, pp. 893-943.
9. Knight, M. (2006) “Separations of hydrophobic synthetic peptides in counter-current chromatography”, J. Chromatogr. A, 1151:148-152.
10. Ito, Y., Fitze, P E and Sullivan, j. (2003) “Spiral disk assembly for high-speed countercurrent chromatography.” J. Chromatog. & Related Techniques, 26:1355-1372.
11. Ito, Y. Yang, F.-Q., Powell, J., Ide, D. (2003) Improved spiral disk assembly for high-speed counter-current chromatography, J. Liq. Chromatog. A 1017:71-81.
12. Knight, M., Finn, T. M, Spiral countercurrent chromatography studies using the spiral disk assembly, Journal of Liquid Chromatography and Related Technologies, (2009) 32:2669-2685.
13. Ito, Y., Knight, M., Finn, T M, Spiral Countercurrent Chromatography, Journal of Chromatographic Science (2013) 51:726-738.
14. Ito. Y., Qi, L., Powell, J., Sharpnack, F., Metger, H., Yost, J., Mixer-settler countercurrent chromatography with a barricaded spiral disk assembly with glass beads, J. Chromatography A, (2007) 1151:108-114.
15. Ito, Y., Clary, R., Sharpnack, F., Metger, H. and Powell, J.; Mixer-settler counter-current chromatography with multiple spiral disk assembly, J Chromatography A, (2007) 1172: 151-159.
16. Tu, X., Mandohar, S., Jagota, A, Zheng, M., DNA sequence motifs for structure-specific recognition and separation of carbon nanotubes, (2009) Nature, 460:doi:10.1038/nature08116.
17. Tanaka, T., Urabe Y., Nishide, D., Kataura, H., Continuous Separation of Metallic and Semiconducting Carbon Nanotubes Using Agarose Gel, Applied Physics Express, 2(2009)125002.
18. Khripin, C. Y., Fagan, J. A., Zheng, M., Spontaneous Partition of Carbon Nanotubes in Polymer-Modified Aqueous Phases, J. Am. Chem. Soc. 2013, 135, 6822-6825.
19. Shibusawa, Y., Takeuchi, N., Sugawara, K., Yanagida, A., Shindo, H., Ito, Y. (2006) “Aqueous-aqueous two-phase systems composed of low molecular weight of polyethylene glycols and dextrans for counter-current chromatographic purifications of proteins” J. Chromatog. B, 844:217-222.
20. Erlanger, B. F., Cooper, A, G., Cohen, W. The Inactivation of Chymotrypsin by Diphenylcarbamyl Chloride and its Reactivation by Nucleophilic Agents, (1966) Biochem. 5:190-196.
21. Conway, W. D, (1995) Chapter 1 “Overview of Countercurrent Chromatography” ACS Symposium Series 593 “Modern Countercurrent Chromatography” W. D. Conway, R. J. Petroski, eds. American Chemical Society, Washington, DC, pp. 1-14.
22. Zhang et al. (2014) Analytical Chemistry 86(8)3980-3984.

We claim:

1. A planetary countercurrent chromatography centrifuge comprising:
1) vertical solar and planetary shafts with a revolution radius of at least 13 cm; and
2) a rotor of at least 22 cm outer diameter comprising a plurality of disks, each disc comprising a channel comprising a device to impede flow, and gaskets,
wherein said disks and said gaskets comprise a central void not in contact with said shafts, and each disc comprises a gasket thereon.

2. The centrifuge of claim 1 wherein said shafts comprise a sealed bearing.

3. The centrifuge of claim 1 wherein said shafts comprise a terminal flared portion.

4. The centrifuge of claim 1, comprising at least six disks.

5. The centrifuge of claim 1, comprising at least eight discs.

6. The centrifuge of claim 1 wherein said discs comprise a raised lip about an outer edge of said disk.

7. The centrifuge of claim 1 wherein said discs comprise a raised lip about an inner edge of said disk.

8. The centrifuge of claim 6 wherein said gaskets seat within said raised lip.

9. The centrifuge of claim 7 wherein said gaskets seat within said raised lip.

10. The centrifuge of claim 1 wherein said rotor comprises ribbed endplates.

11. The centrifuge of claim 1 wherein said rotor comprises a tubing protector.

12. The centrifuge of claim 11 wherein said tubing protector comprises a sleeve.

13. The centrifuge of claim 12 wherein said sleeve is corrugated.

14. The centrifuge of claim 11 wherein said tubing protector comprises a foam, a sponge or a hydrogel.
